(19) United States
(12) Patent Application Publication
(10) Pub. No.: US 2022/0075066 A1
(43) Pub. Date: Mar. 10, 2022

(54) OPTICAL RANGING DEVICE

(71) Applicant: DENSO CORPORATION, Kariya-city (JP)

(72) Inventor: Kenta AZUMA, Kariya-city (JP)

(21) Appl. No.: 17/455,637

(22) Filed: Nov. 18, 2021

Related U.S. Application Data
(63) Continuation of application No. PCT/JP2020/019082, filed on May 13, 2020.

(30) Foreign Application Priority Data
May 20, 2019 (JP) 2019-094254

(51) Int. Cl. G01S 17/42; G01S 7/4865; G01S 7/484; G01S 7/4863; G01C 3/06

(52) U.S. Cl. CPC G01S 17/42; G01S 7/4865; G01C 3/06; G01S 7/4863; G01S 7/484

(57) ABSTRACT

In an optical ranging device for measuring a distance to an object using light, an optical system is configured to image reflected light from a predefined region corresponding to pulsed light to a pixel that performs detection, within which a plurality of sub-pixels arranged. A timing control unit is configured to cause detection of the reflected light, which is repeated at time intervals by at least some of the plurality of sub-pixels, and detection of the reflected light, which is repeated at the time intervals by others of the plurality of sub-pixels, to be performed at different phases. A determination unit is configured to, using a result of detection of the reflected light repeated at the time intervals by each of the plurality of sub-pixels, determine a spatial position of the object present in the predefined region range, including a distance to the object.

### CROSS-REFERENCE TO RELATED APPLICATION

This application is a continuation application of International Application No. PCT/JP2020/019082 filed May 13, 2020 which designated the U.S. and claims priority to Japanese Patent Application No. 2019-094254 filed with the Japan Patent Office on May 20, 2019, the contents of each of which are incorporated herein by reference.

### BACKGROUND

### Technical Field

The present disclosure relates to a technique for detecting an object using light.

### Related Art

Techniques are known for emitting pulsed light, such as a laser beam, and receiving reflected light from an object by a light receiving unit, and measuring a time of flight (TOF) from emission to reception of the light, and thereby detecting the presence or absence of an object or measuring a distance to the object. In such techniques, various efforts have been made to improve the resolution of capturing objects. There are two types of resolutions: one is the resolution for detecting a position of an object in space (hereinafter referred to as spatial resolution), and the other is the resolution for measuring a time of flight corresponding to a distance to the object (hereinafter referred to as temporal resolution). The former resolution can be improved by reducing the size of a light emitting element or a light receiving element. For example, in a known technique, a plurality of light emitting elements having a light emitting region smaller than a light receiving region of the light receiving element are provided. Causing the plurality of light emitting elements to emit light in a time multiplexed manner enables acquisition of a distance image with a resolution higher than that of the light receiving element.

### BRIEF DESCRIPTION OF THE DRAWINGS

In the accompanying drawings:

FIG. 1 is a schematic diagram of an optical ranging device according to a first embodiment;

FIG. 2 is an illustration of a detailed configuration of an optical system;

FIG. 3 is a block diagram of an internal configuration of a SPAD calculation unit;

FIG. 4 is an illustration of an example of SPAD circuits forming a light receiving circuit;

FIG. 5 is an illustration of peak detection by superimposing results of detection by respective SPAD circuits;

FIG. 6 is a block diagram of detailed configurations of an integration unit, a histogram generation unit, and a peak detection unit;

FIG. 7 is an illustration of an internal configuration of a timing control circuit and timing control signals output to each integrator;

FIG. 8 is an illustration of phase differences of detection between sub-pixels, taking four sub-pixels as an example;

FIG. 9 is a flowchart of a ranging process;

FIG. 10 is an illustration of an example of a histogram generated by each histogram generator;

FIG. 11 is an illustration of another example of a histogram generated by each histogram generator;

FIG. 12 is an illustration of the internal configuration of the timing control circuit and timing control signals output to respective integrators according to a second embodiment;

FIG. 13 is an illustration of detecting a peak by superimposing results of detection by SPAD circuits in the second embodiment;

FIG. 14 is an illustration of changing phases at the timing of detection by the sub-pixels in the second iteration as another ranging process;

FIG. 15 is an illustration of an example of a combination of two sub-pixels;

FIG. 16 is an illustration of another example of a combination of two sub-pixels;

FIG. 17 is an illustration of an example of a combination of four sub-pixels;

FIG. 18A is an illustration of an example of a combination of 3×3 sub-pixels from 4×4 sub-pixels; and

FIG. 18B is an illustration of an example of a change from a combination of 4×4 sub-pixels to a combination of 2×2 sub-pixels.

### DESCRIPTION OF SPECIFIC EMBODIMENTS

In the above known technique, as disclosed in JP-A-2016-176721, laser diodes having a small light emitting region emit laser light in a time multiplexed manner in one ranging, which may lead to an increased ranging time and thus may lead to a decrease in the frame rate. Instead, a technique may be devised that divides the interior of the light receiving element into a plurality of sub-pixels to enable detection at each sub-pixel. Such a technique can improve the spatial resolution, but can not improve the temporal resolution as it is.

One aspect of the present disclosure provides an optical ranging device for measuring a distance to an object using light. In the optical ranging device, a light emitting unit is configured to emit pulsed light into a predefined region. An optical system is configured to image reflected light from the predefined region corresponding to the pulsed light to a pixel that performs detection. A light receiving unit includes a plurality of sub-pixels arranged within the pixel, each of the plurality of sub-pixels being configured to detect the reflected light. A timing control unit is configured to cause detection of the reflected light, which is repeated at time intervals by at least some of the plurality of sub-pixels, and detection of the reflected light, which is repeated at the time intervals by others of the plurality of sub-pixels, to be performed at different phases. A determination unit is configured to, using a result of detection of the reflected light repeated at the time intervals by each of the plurality of sub-pixels, determine a spatial position of the object present in the predefined region range, including a distance to the object.

With the optical ranging device configured as above, detection of the reflected light, which is repeated at time intervals by at least some of the plurality of sub-pixels, and detection of the reflected light, which is repeated at the time intervals by others of the plurality of sub-pixels, are performed at different phases. By using the results of detection repeated by each sub-pixel at the time intervals, the temporal resolution can be increased by the phase difference of detection between the sub-pixels, and the spatial resolution can be increased by using the results of detection by multiple sub-pixels, in determining the spatial position of the object, including the distance to the object present in the predefined region.

### A. First Embodiment

(A1) Device Configuration

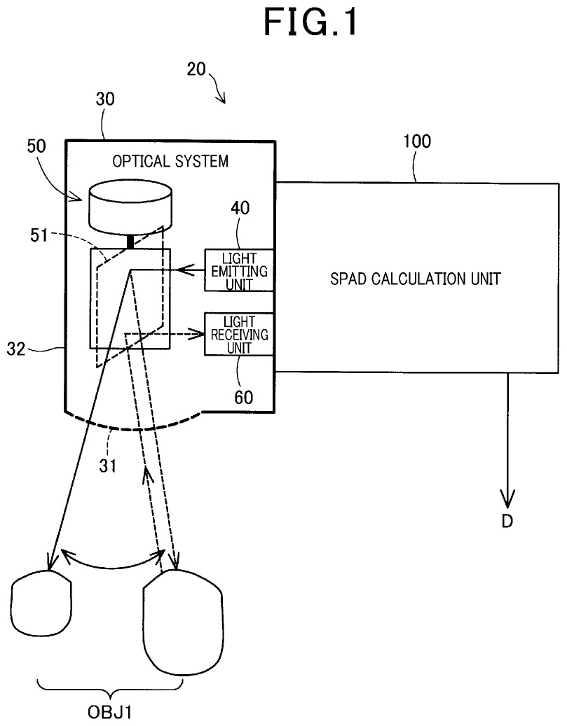

An optical ranging device 20 that is an optical device according to a first embodiment is configured to optically measure a distance to an object. As illustrated in FIG. 1, the optical ranging device 20 includes a SPAD calculation unit 100 configured to drive an optical system 30 that projects light onto an object OBJ1, a distance to which is to be measured, and receives reflected light therefrom and process signals acquired from the optical system 30. The optical system 30 includes a light emitting unit 40 configured to emit a laser beam, a scanning unit 50 configured scan a predefined region with the laser beam from the light emitting unit 40, and a light receiving unit 60 configured to receive reflected light from the region scanned with the laser beam.

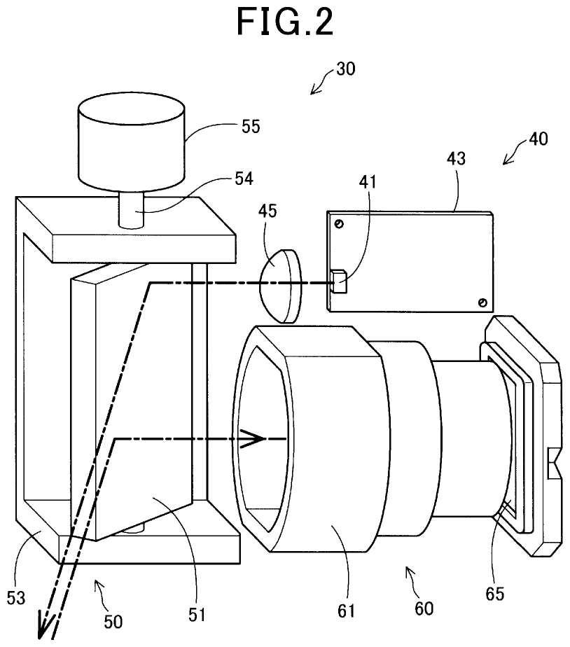

FIG. 2 illustrates details of the optical system 30. As illustrated in FIG. 2, the light emitting unit 40 includes a semiconductor laser element (hereinafter referred to simply as a laser element) 41 that emits a laser beam for ranging, a circuit board 43 incorporating a drive circuit for driving the laser element 41, and a collimating lens 45 that collimates the laser beam emitted from the laser element 41 into a collimated beam. The laser element 41 is a laser diode operable as a so-called short pulsed laser, and the pulse width of the laser light is about 5 nsec. Use of short pulses of 5 nsec can improve the ranging resolution.

The scanning unit 50 includes a surface mirror 51 that reflects the laser beam collimated by the collimating lens 45, a holder 53 that rotatably holds the surface mirror 51 by a rotary shaft 54, and a rotary solenoid 55 that rotationally drives the rotary shaft 54. The rotary solenoid 55 repeats forward rotation and reverse rotation of the rotary shaft 54 within a predefined angular range (hereinafter referred to as a range of field angles) in response to an external control signal Sm. This allows the rotary shaft 54, and thus the surface mirror 51 as well, to rotate within this predefined angular range. Thus, lateral (H-directional) scan over the predefined range of field angles is implemented with the laser beam incident from the laser element 41 through the collimating lens 45. The rotary solenoid 55 includes an encoder (not shown) to output a rotation angle. Therefore, a scan position can be acquired by reading the rotation angle of the surface reflector 51 as the output of the encoder.

The lateral (H-directional) scan with the laser beam emitted from the light emitting unit 40 is implemented by driving the surface mirror 51 within the predefined angular range. The laser element 41 has an elongated shape in a direction perpendicular to the H direction (hereinafter referred to as a V direction). The optical system 30 including the surface reflector 51 of the scanning unit 50 described above is housed within a housing 32, and the light emitted toward the object OBJ1 and reflected light from the object OBJ1 pass through a cover 31 provided in the housing 32.

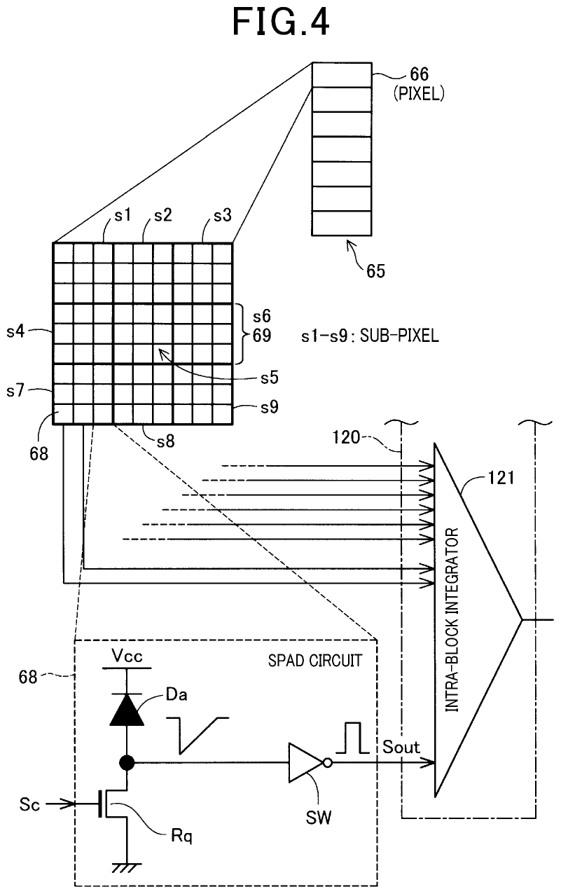

The scanning unit 50 implements scan with the pulsed light emitted from the laser element 41 over a region predefined by a V-directional height of the laser light and the angular range in the H-direction. In the presence of an object OBJ1 such as a person or a car in this region, the laser light output from the optical ranging device 20 toward this region is diffusely reflected on the surface the object, and a portion of the laser light is returned to the surface mirror 51 of the scanning unit 50. This reflected light is reflected by the surface mirror 51 and enters a light receiving lens 61 of the light receiving unit 60. The reflected light collected by the light receiving lens 61 provides an image on a light receiving array 65 forming a light receiving surface. As illustrated in FIG. 4, a plurality of light receiving elements 66 for detecting reflected light are arranged in the light receiving array 65.

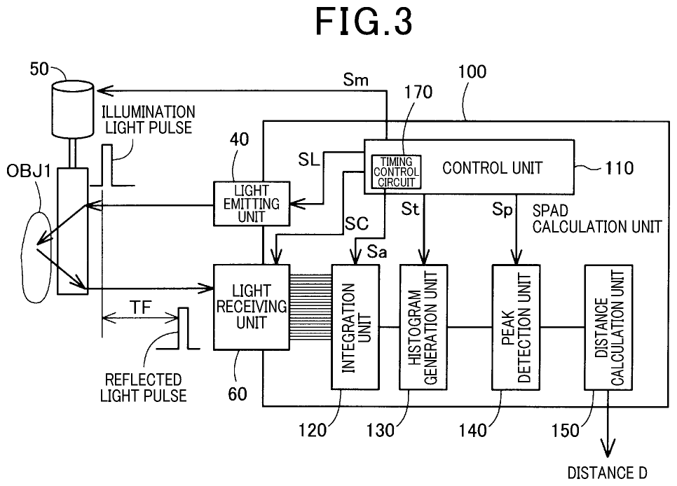

As illustrated in FIG. 3, output signals from the light receiving array 65 of the light receiving unit 60 are input to the SPAD calculation unit 100. The configuration and functions of the SPAD calculation unit 100 will now be described with reference to FIGS. 3 and 4. The SPAD calculation unit 100 calculates a distance to the object OBJ1 from a time TF from emission of an illumination light pulse by the laser element 41 to reception of a reflected light pulse by the light receiving array 65 of the light receiving unit 60, while scanning the external space by causing the laser element 41 to emit light. The SPAD calculation unit 100 includes a CPU and a memory that are well known, and performs a process necessary for ranging by the CPU executing a program prestored in the memory. More specifically, the SPAD calculation unit 100 includes a control unit 110 for overall control, an integration unit 120, a histogram generation unit 130, a peak detection unit 140, a distance calculation unit 150, and a timing control circuit 170, and the like.

As illustrated in FIG. 4, a plurality of light receiving elements 66 are arranged in the light receiving array 65 of the light receiving unit 60. Each light receiving element 66 is also referred to as a pixel 66 in the following description, since it is a normal unit for detecting reflected light. Each pixel 66 is formed of 3×3 sub-pixels 69.

In the present embodiment, each sub-pixel 69 is formed of a plurality 3×3 SPAD circuits 68. As illustrated in FIG. 4, the 3×3 sub-pixels 69 have the same configuration in that they are all formed of 3×3 SPAD circuits 68, but their arrangement in the pixel 66 is different. When it is necessary to distinguish each sub-pixel 69, they are referred to as sub-pixels s1, s2 . . . s9 in order from the sub-pixel 69 in the upper left corner to the sub-pixel 69 in the lower right corner. The number of sub-pixels 69 forming the pixel 66 may be any number as long as it is greater than one. Preferably, taking into account the lower limit of resolution, the effect of improvement of the S/N ratio, and the like, the number of sub-pixels 69 forming the pixel 66 is about 4 (e.g., 2×2) to 16 (e.g., 4×4).

The integration unit 120 is a circuit for integrating outputs of the SPAD circuits 68 forming the sub-pixels 69 included in the pixels 66 forming the light receiving unit 60. In the present embodiment, the light receiving array 65 of the light receiving unit 60 includes a plurality of pixels 66 arranged in the V direction of the reflected light, as illustrated in FIG. 4. Each pixel 66 is a unit for detecting an object OBJ1 and measuring a distance to the object OBJ1 during ranging. Each pixel 66 is formed of 3×3 sub-pixels 69, and each sub-pixel 69 can be individually controlled on and off. That is, in the present embodiment, nine sub-pixels s1 to s9 in each pixel 66 can be individually actuated.

Each SPAD circuit 68 is formed of an avalanche photodiode (APD), which provides high responsiveness and excellent detection capability. When reflected light (photons) is incident on the APD, electrons and holes are generated, and the electrons and the holes are each accelerated in a high electric field, and the electron and the holes collide one after another and are ionized. Thus, new electron and hole pairs are generated (avalanche phenomenon). In this manner, the APD can amplify incidence of photons, and is thus often used in a case where reflected light has a reduced intensity as is the case with a far object. The APD has operation modes including a linear mode in which the APD is operated at a reverse bias voltage lower than a breakdown voltage and a Geiger mode in which the APD is operated at a reverse bias voltage equal to or higher than the breakdown voltage. In the linear mode, the numbers of electrons and holes exiting a high electric field area and disappearing are larger than the numbers of electrons and holes generated, and annihilation of the electron and hole pairs stops naturally. Thus, an output current from the APD is substantially proportional to the amount of incident light.

In the Geiger mode, incidence of even a single photon can cause the avalanche phenomenon, enabling a further increase in detection sensitivity. Such an APD operated in the Geiger mode may be referred to as a single photon avalanche diode (SPAD).

In the equivalent circuit of each SPAD circuit 68 illustrated in FIG. 4, an avalanche diode Da and a quench resistor Rq are connected in series between the power supply Vcc and the ground line, and the voltage at the connection point between the avalanche diode Da and the quench resistor Rq is input to an inverting element INV that is one of logic operation elements, and is converted into a digital signal of the inverted voltage level. The output signal Sout of the inverting element INV is externally output as it is. The quench resistor Rq is configured as a FET. When a selection signal SC is active, its on resistance serves as the quench resistor Rq. When the selection signal SC is inactive, the quench resistor Rq is in a high impedance state, such that even if light is incident on the avalanche diode Da, no quench current flows, and thus the SPAD circuit 68 does not operate. The selection signal SC is output collectively to the 3×3 SPAD circuits 68 in some or all of the sub-pixels 69, and is used to specify from which sub-pixels 69 of each pixel 66 the signal is to be read out. The avalanche diode Da may be used in the linear mode and its output may be handled as an analog signal. It is also possible to use a PIN photodiode in place of the avalanche diode Da.

When no light is incident on the SPAD circuit 68, the avalanche diode Da is kept in a non-conductive state. Therefore, the input side of the inverting element INV is pulled up via the quench resistor Rq, that is, the input side of the inverting element INV is kept at the high level H. The output of the inverting element INV is thus kept at the low level L. When light is externally incident on the SPAD circuit 68, the avalanche diode Da is energized by the incident photon. A large current then flows through the quench resistor Rq, the input side of the inverting element INV becomes the low level L once, and the output of the inverting element INV is inverted to the high level H. As a result of the large current flowing through the quench resistor Rq, the voltage applied to the avalanche diode Da decreases, such that power supply to the avalanche diode Da stops and the avalanche diode Da is restored to the non-conductive state. Thus, the output signal of the inverting element INV is also inverted and returns to the low level L. Accordingly, the inverting element INV outputs a pulse signal that is at a high level for a very short time when a photon is incident on the SPAD circuit 68. Setting the selection signal SC to the high level H at the timing the SPAD circuit 68 receives light will lead to the output signal of the AND circuit SW, that is, the output signal Sout from the SPAD circuit 68, becoming a digital signal reflecting the state of the avalanche diode Da.

As illustrated in FIG. 4 for any one of the sub-pixels 69, a total of nine output signals Sout of the 3×3 SPAD circuits 68 included in the sub-pixel 69 are input to an intra-block integrator 121 prepared in the integration unit 120 and integrated. The integration unit 120 includes nine intra-block integrators 121 to 129. In the following description, each intra-block integrator is also referred to simply as an integrator. The outputs of the nine SPAD circuits 68 in each sub-pixel 69 are integrated by a corresponding one of the integrators 121 to 129, output to the histogram generation unit 130, and used for generating a histogram.

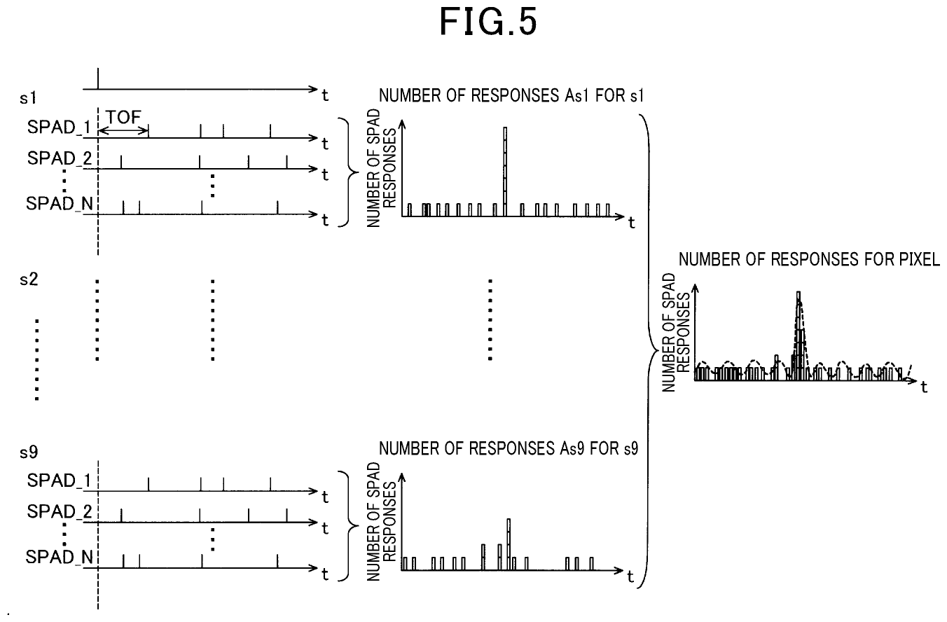

As an example, referring to FIG. 5, when the laser element 41 of the light emitting unit 40 emits light and its reflected light from the object OBJ1 is incident on the pixel 66 corresponding to one of the pixels arranged on the light receiving surface of the light receiving unit 60, each sub-pixel 69 outputs pulse signals at the timing (of TOF) of receipt of the reflected light. More specifically, as illustrated in the left column of FIG. 5, each of the SPAD circuits 68 forming any one of the sub-pixels s1 to s9 outputs the output signals Sout at various timings, due in part to effects of disturbing light (noise). These are SPAD_1 to SPAD_N (where N=9) in the left column of FIG. 5. t in FIG. 5 indicates the time (the same in other drawings).

For each of the sub-pixels s1 to s9, the output signals Sout output by the SPAD circuits 68 of the sub-pixel are integrated by a corresponding one of the integrators 121 to 129, such that the numbers of SPAD responses As1 to As9 are acquired as illustrated in the center of FIG. 5. As illustrated in FIG. 5, although each SPAD circuit 68 also outputs signals Sout due to noise, the SPAD circuit 68 outputs an output signal Sout at or around the time of flight TOF corresponding to the reflected light of the pulsed light emitted by the laser element 41. Therefore, the numbers of SPAD responses As1 to As9, each acquired by integrating the output signals from the SPAD circuits 68 of a corresponding one of the sub-pixels, peak at the time of flight TOF. The numbers of SPAD responses As1 to As9 for the sub-pixels s1 to s9 are integrated to acquire a histogram for the pixel 66. This is illustrated in the right column of FIG. 5.

The histogram generation unit 130 superimposes the numbers of SPAD responses As1 to As9 acquired by the integration unit 120 for the sub-pixels s1 to s9 by performing multiple measurements at the same scanning position. This allows a histogram having a peak at the time of flight TOF to be generated as illustrated in the right column of FIG. 5. Through integrating the numbers of SPAD responses As1 to As9 for the sub-pixels s1, s2, . . . , s9, a peak in the number of responses is formed at or around the time TOF. Disturbing light such as sunlight generates random noise. Since pulse signals caused by noise are generated randomly, noise appears randomly even after the output signals Sout from the SPAD circuits 68 for each of the sub-pixels s1, s2, . . . , s9 are integrated and then the numbers of SPAD responses As1 to As9 for the sub-pixels s1, s2, . . . , s9 are integrated. Whereas, a peak is acquired at the specific time of flight when the reflected light from the object OBJ1 is detected. That is, the signals corresponding to the reflected light pulse are accumulated but the signals corresponding to the noise are not. This makes the signal corresponding to the reflected light pulse clear. The so-called S/N ratio therefore becomes high.

Upon the histogram generation unit 130 generating the histogram for each pixel, the peak detection unit 140 detects a signal peak. The signal peak is generated at the time of flight corresponding to the reflected light pulse from the object OM, a distance to which is to be measured. When the signal peak is thus detected, the distance calculation unit 150 detects a distance D to the object by detecting a time TOF from emission of the illumination light pulse to the peak corresponding to the reflected light pulse. The detected distance D may be externally output to, for example, an autonomous driving device of an autonomous driving vehicle carrying the optical ranging device 20, or may be mounted to various mobile objects, such as a drone, a car, a ship or the like, or may be used alone as a fixed ranging device.

The control unit 110, as illustrated in FIG. 3, outputs a command signal SL to the circuit board 43 of the light emitting unit 40 for determining the timing of emission by the laser element 41, a selection signal SC for determining whether to activate the SPAD circuits 68, a signal St to the histogram generation unit 130 for instructing the histogram generation timing and the histogram correction timing, a signal Sp to the peak detection unit 140 for switching the peak detection threshold Tn, a drive signal Sm to the scanning unit 50 for driving the rotary solenoid 55 of the scanning unit 50, and the like. Further, the timing control unit 170 provided in the control unit 110 outputs to the integration unit 120 a timing control signal Sa for adjusting the phase in integration for each sub-pixel 69. Outputting these signals at timings predefined by the control unit 110 allows the SPAD calculation unit 100 to serve as a determination unit configured to detect a spatial position of an object OBJ1 present in a predefined region, as well as a distance D to the object OBJ1.

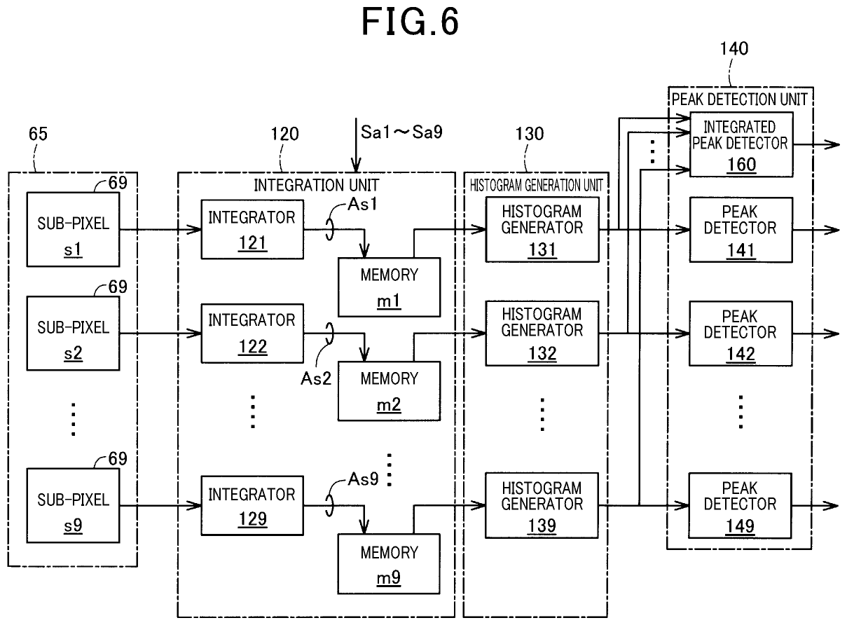

Next, the configuration of each of the integration unit 120, the histogram generation unit 130, and the peak detection unit 140 in the present embodiment, and the configuration and operation of the timing control unit 170 that adjusts the operation timing of each of these units will be sequentially described. As illustrated in FIG. 6, the nine sub-pixels 69 (s1 to s9) forming the pixel 66 are respectively connected to the integrators 121 to 129 forming the integration unit 120. The configuration of each of the integrators 121 to 129 has already been described using FIG. 4. The integrators 121 to 129 calculate the numbers of SPAD responses As1 to As9, respectively, from the outputs of the 3×3 SPAD circuits 68 provided in the respective sub-pixels s1 to s9.

The numbers of SPAD responses As1 to As9 output by the integrators 121 to 129 are input to the memories m1 to m9 and are sequentially stored in the memories m1 to m9. The number of SPAD responses As1, . . . , the number of SPAD responses As9 stored in the memories m1 to m9 are read at a predefined timing by histogram generators 131 to 139 provided in the histogram generation unit 130 of the next stage.

Each of the histogram generators 131 to 139 integrates results of detection performed multiple times by a corresponding one of the sub-pixels 69, that is, corresponding multiple numbers of SPAD responses, to generate the histograms T1 to T9 for the respective sub-pixels s1 to s9. The generated histograms T1 to T9 are input to the respective peak detectors 141 to 149 of the peak detection unit 140. The generated histograms T1 to T9 are input together to an integrated peak detector 160. Each of the peak detectors 141 to 149 detects the position of the peak and the time of flight TOF on the time axis based on a corresponding one of the histograms T1 to T9 generated for the respective sub-pixels s1 to s9. This is the time of flight of the reflected light from the object, associated with the corresponding one of the sub-pixels s1 to s9. The integrated peak detector 160 detects the position of the peak and the time of flight TOF on the time axis based on the integrated histogram TT, which is an integrated histogram of the histograms T1 to T9 generated for all the respective sub-pixels s1 to s9. This is the time of flight of the reflected light from the object, associated with the pixel 66 formed of the sub-pixels s1 to s9.

The integrators 121 to 129 and the memories m1 to m9 described above each operate at a timing determined by the timing control signal Sa from the timing control unit 170 in the control unit 110 to read and store the signals from the SPAD circuits 68. The configuration of the timing control unit 170 and the timing control signal Sa output by the timing control unit 170 will now be described.

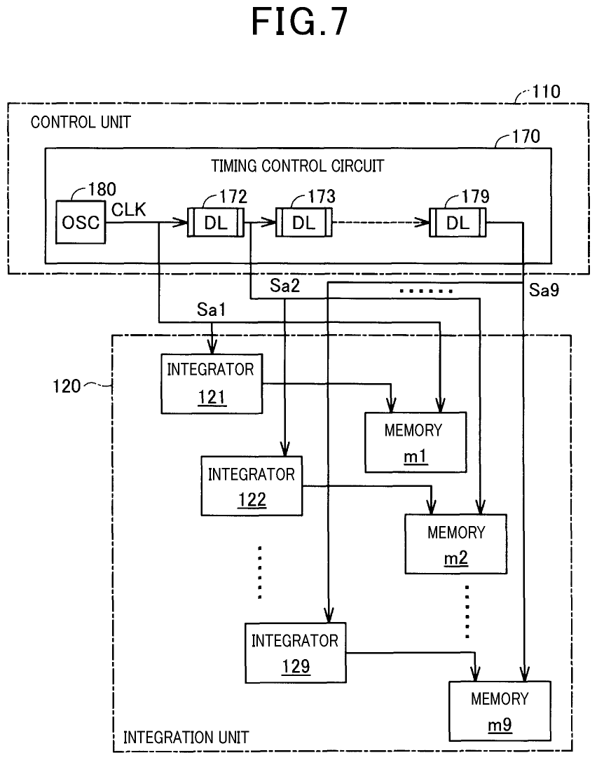

As illustrated in FIG. 7, the timing control unit 170 includes an oscillator (OSC) 180 that outputs a clock signal CLK of a predefined frequency, and eight-stage delay circuits 172 to 179 that receive the clock signal CLK and stepwise delay the phase of the clock signal CLK by a predefined time. The clock signal CLK output by the oscillator 180 is input to trigger terminals of the integrator 121 and the memory m1 as a reference timing control signal Sa. Upon receipt of the timing control signal Sa1 at the trigger terminals, the integrator 121 outputs the number of SPAD responses As1 and the memory m1 stores it at that timing. The timing control signal Sat2 whose phase is delayed from the reference timing control signal Sa1 by a delay time DL by the delay circuit 172, is input to the trigger terminals of the integrator 122 and the memory m2. Upon receipt of the timing control signal Sa2 at the trigger terminals, the integrator 122 outputs the number of SPAD responses As2 and the memory m2 stores it at that timing. Thereafter, in the same manner, upon receipt of the timing control signals Sa3 to Sa9 whose phases are delayed relative to each other, the integrators 123 to 129 output the respective numbers of SPAD responses As3 to As9 and the memories m3 to m9 stores the respective numbers of SPAD responses As3 to As9 at the respective timings. Although not shown in FIG. 7, the numbers of SPAD responses As1 to As9 stored by the respective memories m1 to m9 are read by the respective peak detectors 141 to 149 and the integrated peak detector 160 provided in the peak detection unit 140 of the later stage at a desired timing.

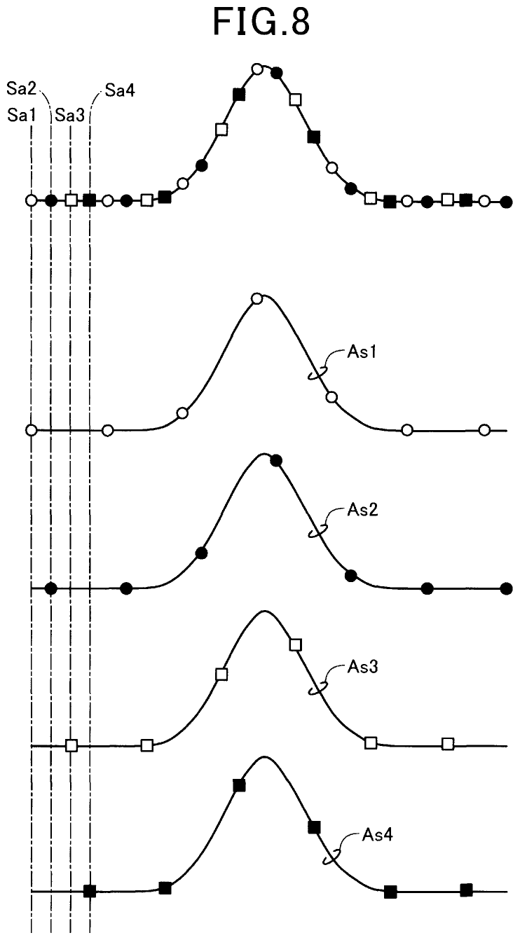

FIG. 8 illustrates reading of the numbers of SPAD responses acquired in response to such timing control signals whose phases are gradually delayed relative to each other. In FIG. 8, for convenience of understanding, four SPAD circuits 68 are used. In FIG. 8, each unfilled circle indicates that the number of SPAD responses is acquired in response to the timing control signal Sa1, and each filled circle indicates that the number of SPAD responses is acquired in response to the timing control signal Sa2 whose phase is delayed by the delay time DL from the timing control signal Sa1. Each unfilled square indicates that the number of SPAD responses is acquired in response to the timing control signal Sa3 whose phase is delayed by the delay time DL from the timing control signal Sa2, and each filled square indicates that the number of SPAD responses is acquired in response to the timing control signal Sa4 whose phase is delayed by the delay time DL from the timing control signal Sa3.

As illustrated in the top row of FIG. 8, the number of SPAD responses is repeatedly acquired in response to each timing control signal Sa1 to Sa4. The number of SPAD responses As1 acquired each time the timing control signal Sa1 is received is shown in the second row, the number of SPAD responses As2 acquired each time the timing control signal Sa2 is received is shown in the third row, the number of SPAD responses As3 acquired each time the timing control signal Sa3 is received is shown in the fourth row, and the number of SPAD responses As4 acquired each time the timing control signal Sa4 is received is shown in the fifth row. In the topmost row in FIG. 8, these four numbers of SPAD responses As1 to As4 are integrated.

As illustrated in FIG. 8, the timings of sampling of the numbers of SPAD responses As1 to As4 detected at the respective sub-pixels s1 to s4 is shifted by the delay time DL of the delay circuit 172 relative to each other. In the example illustrated in FIG. 8, since the delay time DL is set so as to divide the cycle of light emission by the light emitting unit 40 into exactly four equal parts, no overlap occurs in detection of the numbers of SPAD responses As1 to As4 at the respective sub-pixels s1 to s4. In the present embodiment illustrated in FIGS. 1 to 7, 3×3 sub-pixels 69 are provided. Hence, in the actual configuration, the delay time DL is set to divide the emission period of the illumination pulse from the light emitting unit 40 into nine equal parts. That is, the time interval of detection by the sub-pixels s1 to s9 is shorter than the width of pulsed light emitted by the light emitting unit 40.

(A2) Detailed Ranging Process

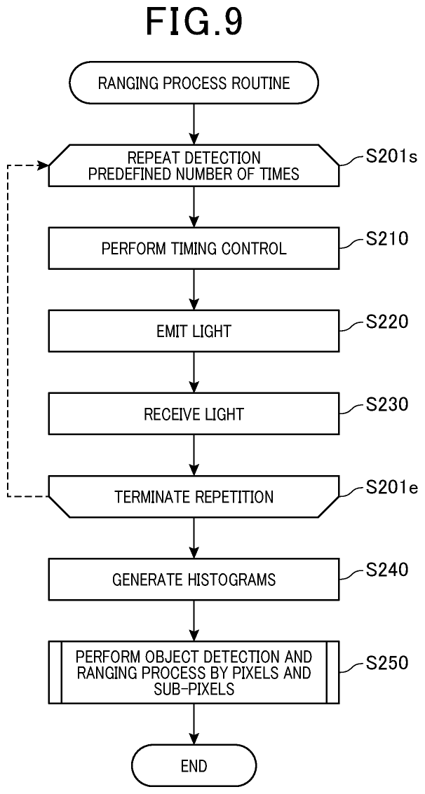

On the premise of the hardware configuration described above, control performed by the CPU in the control unit 110 will now be described with reference to FIG. 9. The ranging process routine illustrated in FIG. 9 is iteratively performed at a predefined time interval. Upon initiation of this ranging process routine, first, process steps S210 to S230 are iterated a predefined number of times for the sub-pixels s1 to s9 (at steps S201s to S201e).

In these process steps to be iterated, timing control is first performed (at step S210). As illustrated in FIGS. 7 and 8, the timing control is a process of preparing timing control signals Sa1 to Sa9 to be output to the integration unit 120 and the histogram generation unit 130 during ranging. In the present example, the timing control signals Sa1 to Sa9 are defined as outputs of the clock signal CLK and the delay circuits 172 to 179, but as described below, each of the timing control signals Sa1 to Sa9 may be arbitrarily specified. Therefore, the timing control process is performed (at step S210).

Upon completion of the timing control, the control unit 110 outputs the command signal SL to the light emitting unit 40 and performs a light emitting process to cause the laser element 41 to emit pulsed light (at step S220), followed by a light receiving process (at step S230). In the light receiving process, the control unit 110 outputs the selection signal SC to the light receiving unit 60, outputs the timing control signals Sa1 to Sa9 to the integration unit 120, calculates and outputs the numbers of SPAD responses As1 to As9 from the above-described integrators 121 to 129, and stores the numbers of SPAD responses As1 to As9 in the memories m1 to m9.

The above process steps (steps S210 to S230) are iterated a predefined number of times. Therefore, upon completion of repetition of these process steps, the numbers of SPAD responses As1 to As9 for the respective sub-pixels s1 to s9 are stored in the respective memories m1 to m9 in response to the timing control signals Sa1 to Sa9 from the timing control unit 170 for the number of repetitions. Subsequently, at step S240, the numbers of SPAD responses As1 to As9 stored for the number of repetitions in the respective memories m1 to m9 are integrated by the respective histogram generators 131 to 139 of the histogram generation unit 130 to generate the respective histograms.

Subsequently, at step S250, using the histograms thus acquired for the respective sub-pixels s1 to s9, an object detection and ranging process is performed for the pixels and the sub-pixels. This process corresponds to the peak detection process performed by the respective peak detectors 141 to 149 in the peak detection unit 140 and the integrated peak detector 160. As described later, at step S250, the sub-pixel 69 based detection and ranging process (first process) and the pixel 66 based detection and ranging process (second process) can be performed. Upon completion of this object detection and ranging process, the ranging process routine is terminated.

The object detection and ranging process for the pixels and the sub-pixels shown as step S250 will now be described. At the beginning of the process step S250, the histogram generators 131 to 139 of the histogram generation unit 130 has generated the respective histograms acquired by integrating the numbers of SPAD responses As1 to As9 stored for the number of repetitions in the respective memories m1 to m9. The histograms acquired for the sub-pixels s1 to s9 are different from each other as the numbers of SPAD responses As1 to As9 are detected at different timings, as illustrated in FIG. 8.

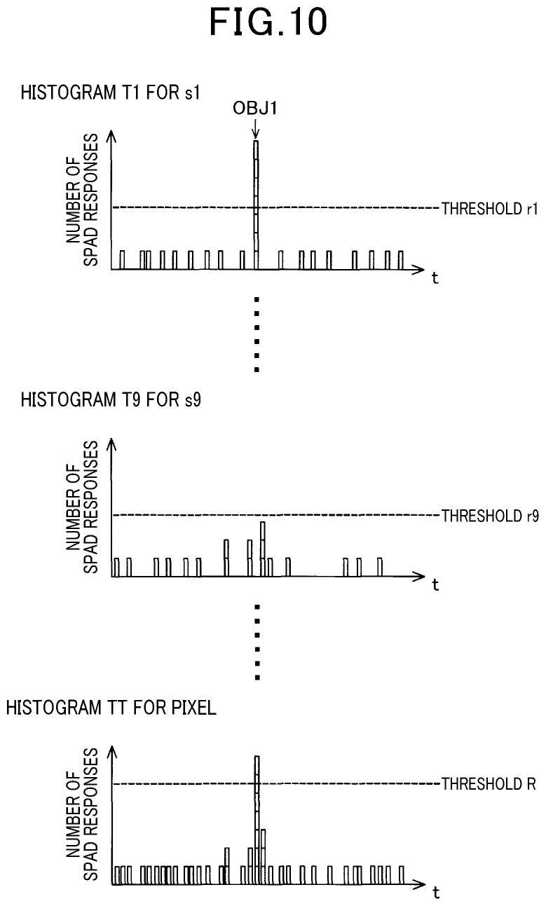

Using the histograms T1 to T9 corresponding to the respective sub-pixels s1 to s9 and the integrated histogram TT which is an integration of these histograms, the peak detection unit 140 detects the peaks. This process is illustrated in FIG. 10. The peak detectors 141 to 149 and the integrated peak detector 160 of the peak detection unit 140 compare the acquired histograms T1 to T9 and the integrated histogram TT with thresholds r1 to r9 and a threshold R, respectively, to thereby detect the presence or absence of a peak and its position on the time axis (the time of flight). There may be a histogram in which there is no peak that exceeds the threshold. That is, the sub-pixels s1 to s9 serve as the limit of spatial resolution in space when detecting the object OBJ1. Moreover, the numbers of SPAD responses As1 to As9 for the respective sub-pixels s1 to s9 are not detected at the same timing, but detected at different timings that are shifted by the delay time DL relative to each other, as illustrated in FIG. 8. As a result, the histograms T1 to T9 acquired by superimposing the respective numbers of SPAD responses As1 to As9 multiple times at different positions on the time axis, which means that they have a higher time resolution on the time axis than the interval of pulse emission. The integrated histogram TT, which is acquired by integrating these histograms T1 to T9, has a high resolution on the time axis, as illustrated in the top row of FIG. 8.

For example, in the example illustrated in FIG. 10, the histogram T1 for the sub-pixel s1 exceeds the threshold r1 at time t1, and a peak therefore is detected. In the histogram T9 for the sub-pixel s9, there is no peak that exceeds the threshold r9 at any time. Further, the integrated histogram TT exceeds the threshold R at the time t1. Therefore, the distance calculation unit 150 determines that the object OBJ1 is present at least at the position corresponding to the sub-pixel s1 and at the time of flight t1, and calculates the position and the distance D. On the other hand, the distance calculation unit 150 determines that the object OBJ1 is not present at the position corresponding to the sub-pixel s9. In addition, looking at pixel 66 as a whole, which is formed of sub-pixels s1 to s9, the distance calculation unit 150 determines that the object OBJ1 is present at the position corresponding to pixel 66 and at the distance D corresponding to the time of flight t1. If a peak is detected at time t2 immediately after time t1 in the histogram T2 for the sub-pixel s2, it is determined that the object OBJ1 is present at the position in space corresponding to the sub-pixel s2 and at the distance corresponding to the time of flight t2, and from the integrated histogram TT, it is determined that the object OBJ1 is present at pixel 66 at the distances corresponding to the times of flight t1 and t2. That is, it can be determined that the object OBJ1 with a size that spans at least sub-pixels s1 and s2 is present at or around the times of flights t1 and t2.

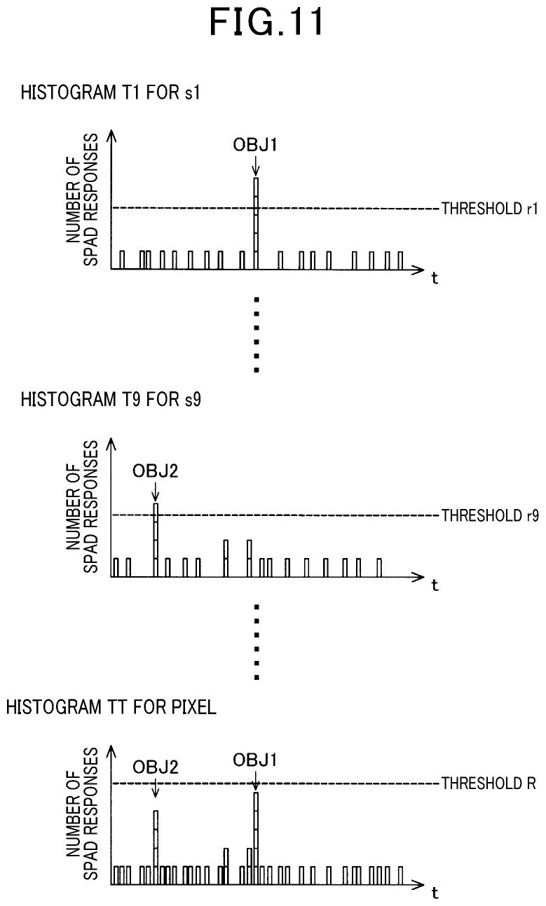

Another example of detection is illustrated in FIG. 11. In the example illustrated in FIG. 11, the histogram T1 for the sub-pixel s1 exceeds the threshold r1 at time t1, and a peak is detected. The histogram T9 for sub-pixel s9 exceeds the threshold value r9 at time t9, and a peak is detected. In addition, it is assumed that no peak is detected at each of the other sub-pixels s2 to s8. The integrated histogram TT is also below the threshold R at each of time t1 and time t9, and no peak is detected. In this case, since small objects OBJ1 and OBJ2 are present at the sub-pixels s1 and s9, and the distances to these objects are quite different as the times of flight t1 and t9, it can be determined that objects of a size corresponding to the sub-pixel are present at different distances. That is, the SPAD calculation unit 100 of the present embodiment is capable of performing a process of detecting objects present in a predefined region at a first spatial resolution and at a first temporal resolution, according to temporally spaced detections by the sub-pixels s1 to s9, and a process of detecting objects OBJ1 and OBJ2 present in the predefined region at a second spatial resolution lower than the first spatial resolution and at a second temporal resolution higher than the first temporal resolution, according to a result of superimposition of temporally spaced detections by the plurality of sub-pixels whose detection phases are different from each other.

As described above, the optical ranging device 20 of the first embodiment can detect a position and a distance of an object at a time resolution higher than a time interval of emission pulses by the light emitting unit 40 and at a spatial resolution higher than the pixel 66. Moreover, the memory capacity required for such detection can be reduced to the same as or less than that required for detection at an increased temporal resolution on a pixel by pixel basis. That is, even though the spatial resolution is increased, the amount of data to be stored does not need to be increased as compared to the case of detection over the entire pixel illustrated in the uppermost row of FIG. 8. In the present embodiment, detection using the timing control signals Sa1 to Ss9 from the timing control unit 170 is repeated, all the data is stored in the respective memories m1 to m9, and then the histograms are generated. In an alternative configuration, each time the timing control signals Sa1 to Sa9 are output, the numbers of SPAD responses As1 to As9 detected in the current cycle may be added to the numbers of SPAD responses As1 to As9 detected in the previous cycle, respectively, and may be then be stored in the respective memories m1 to m9. This configuration can further reduce the capacity of each of the memories m1 to m9. In such a configuration, the histogram generation unit 130 may only be configured to read out the accumulated values stored in the memories m1 to m9.

### B. Second Embodiment

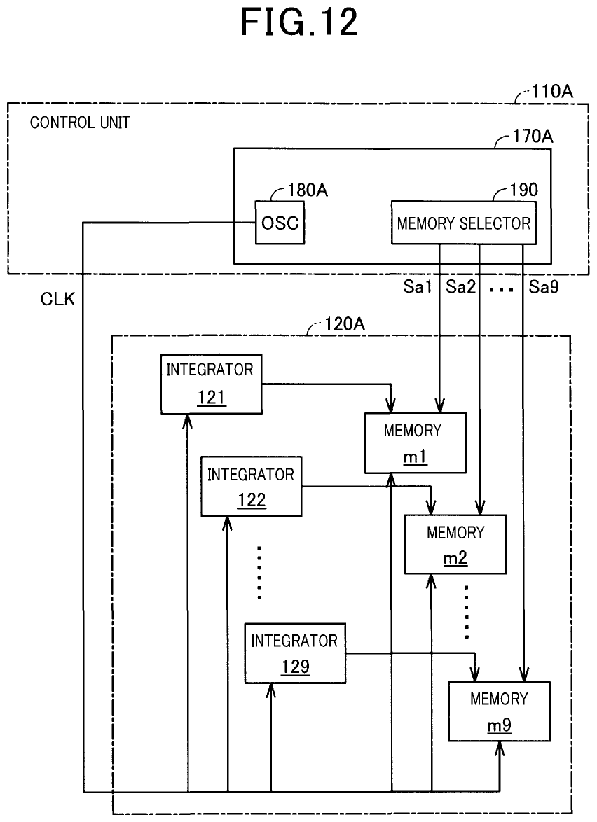

A second embodiment will now be described. The optical ranging device 20 of the second embodiment has the same configuration as that of the first embodiment, except in that the configuration of each of the control unit 110A and the integration unit 120A of the SPAD calculation unit 100 is different. In the second embodiment, the control unit 110A and the integration unit 120A are configured as illustrated in FIG. 12. In the second embodiment, the control unit 110A includes an oscillator 180A and a memory selector 190 as the timing control unit 170A. An oscillation frequency of the oscillator 180A in the second embodiment is about nine times higher than that in the first embodiment. The clock signal CLK output from the oscillator 180A is supplied to the integrators 121 to 129 and the memories m1 to m9 provided in the integration unit 120A. In addition, nine timing control signals Sa1 to Sa9 are output from the memory selector 190 to the memories m1 to m9. The output timings of the respective timing control signals Sa1 to Sa9 are determined in timing control at step S210 described in the ranging process routine in the first embodiment. The timing control signals Sa1 to Sa9 will be described in detail later.

In the optical ranging device 20 of the second embodiment having the above-described configuration, the clock signal CLK of a high frequency is input to the integrators 121 to 129 of the integration unit 120A, and the integrators 121 to 129 acquire the numbers of SPAD responses As1 to As9 upon receipt of each clock signal CLK, as illustrated in the uppermost row of FIG. 8. The numbers of SPAD responses As1 to As9 are acquired by the integrator 121 to 129 adding the outputs of the respective SPAD circuits 68 by hardware, as illustrated in FIG. 4, which provides high responsiveness. Therefore, the numbers of SPAD responses As1 to As9 can be acquired following the clock signal CLK of a higher frequency than that in the first embodiment.

The memories m1 to m9 store the signals of the numbers of SPAD responses As1 to As9 from the integrators 121 to 129, in response to the corresponding timing control signals Sa1 to Sa9. That is, each of the integrators 121 to 129 operates as illustrated in the uppermost row of FIG. 8 to acquire the numbers of SPAD responses As1 to As9 at all receipt timings of the clock signal CLK, while each time any one of the timing control signals Sa1 to Sa9 is output, a corresponding one of the memories m1 to m9 stores at that output timing a corresponding one of the numbers of SPAD responses As1 to As9 having been just output, as illustrated in the second and lower rows of FIG. 8.

Accordingly, given that the timing control signals Sa1 to Sa9 are respectively output at almost the same timings as in the first embodiment, that is, at timings delayed relative to each other by a clock signal CLK, then, as in the first embodiment, the position and distance of the object can be detected at a time resolution higher than the time interval of the emission pulses of the light emitting unit 40 and at a spatial resolution higher than the pixel 66. Such an advantage is the same in other embodiments, including the third embodiment below. Moreover, the memory capacity required for such detection can be reduced to the same or less than that required for detection at a temporal resolution increased on a pixel by pixel basis. That is, even though the spatial resolution is increased, the amount of data to be stored does not need to be increased as compared to the case of detection over the entire pixel illustrated in the uppermost row of FIG. 8. Such advantages can also be achieved in other embodiments including the following third embodiment.

### C. Third Embodiment

As illustrated in FIG. 12, according to hardware employed in the second embodiment described above, the output timings of the respective timing control signals Sa1 to Sa9 output to the memories m1 to m9 of the integration unit 120 can be arbitrarily set by the memory selector 190. Therefore, for example, given that emission of the emission pulse by the light emitting unit 40 and receipt of reflected light by the light receiving unit 60 are repeated multiple times (see steps S201s to S201e in FIG. 9), it is possible to change the output timings of the respective timing control signals Sa1 to Sa9 output from the memory selector 190 in each iteration. This is illustrated below as a third embodiment.

For example, as illustrated in FIG. 13, the storage timings for the memories m1 to m9 may be changed in the timing control (at step S210) in each iteration. In FIG. 13, for convenience of understanding, the numbers of SPAD responses As1 to As4 from the four sub-pixels s1 to s4 are illustrated, as in FIG. 8. In this example, the memory selector 190 outputs the timing control signals Sa1 to Sa4 for the sub-pixels s1 to s4 in the first iteration, wherein the storage timings for the memories m1 to m4 are delayed relative to each other by a clock signal CLK. The resulting numbers of SPAD responses As1 to As4, which are consequently stored in memories m1 to m4, are the same as those illustrated in FIG. 8. The unfilled circles, the filled circles, the unfilled squares, and the filled squares indicate the same timings as in FIG. 8. These are illustrated as the numbers of SPAD responses As11 to As41. Regarding the subscripts of the numbers of SPAD responses Asij, the former i indicates the i-th sub-pixel of the sub-pixels s1 to s4, and the latter j indicates the j-th iteration. For the numbers of SPAD responses As12 to As42 in the second iteration, as illustrated in FIG. 13, the timing control signals Sa1 to Sa4 are cyclically shifted by one sub-pixel as compared to those in the first iteration. Similarly, in the third iteration, the timing control signals are further cyclically shifted by one sub-pixel as compared to those in the second iteration. In the fourth iteration, the timing control signals are further cyclically shifted by one sub-pixel as compared to those in the third iteration.

In the right column of FIG. 13, superimposed numbers of responses At1 to At4 are illustrated. The superimposed number of responses Ati (i=1, 2, 3, 4) is a superimposition of the numbers of SPAD responses for the i-th sub-pixel detected and stored in the memory mi in the first to fourth iterations. The numbers of responses At1 to At4 correspond to the histograms T1 to T4 generated by each histogram generator 131 to 134 of the histogram generation unit 130. Furthermore, it is also possible to integrate the numbers of responses At1 to At4 to acquire the integrated number of responses Att which corresponds to the integrated histogram TT. This is illustrated in the lowest part of FIG. 13.

In this way, a peak of reflected light can be detected over all the sub-pixels s1 to s9 at a high spatial resolution corresponding to the size of each of the sub-pixels s1 to s9 and at a high temporal resolution corresponding to the clock signal CLK. Moreover, the capacities of the memories m1 to m9 do not increase as compared to those in each of the first and second embodiments. In addition, since the timing control signals Sa1 to Sa9 output from the memory selector 190 can be changed each time detection of the numbers of SPAD responses As1 to As9 is repeated, it is not necessary to change the output timings of the timing control signals cyclically as illustrated in FIG. 13. It is also possible to set the same timings for two or more of the multiple iterations of detection and set different timings for the others.

### D. Fourth Embodiment

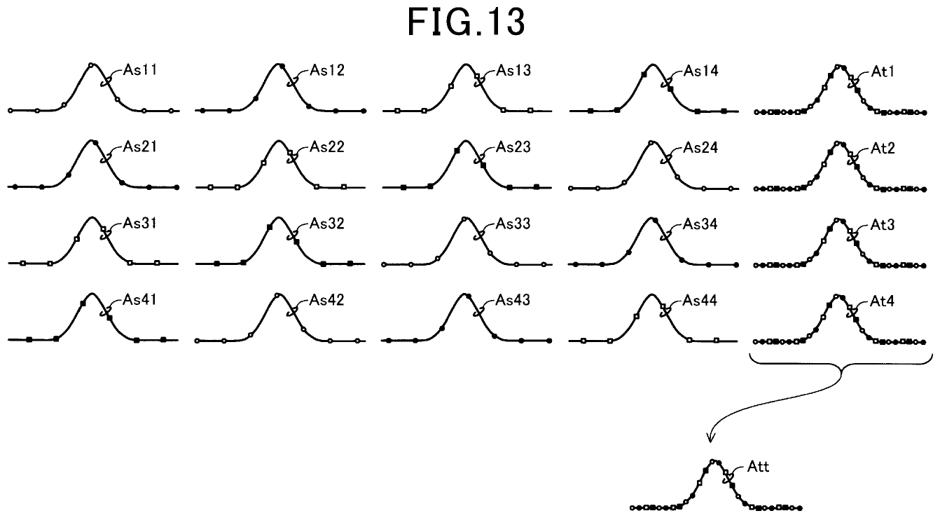

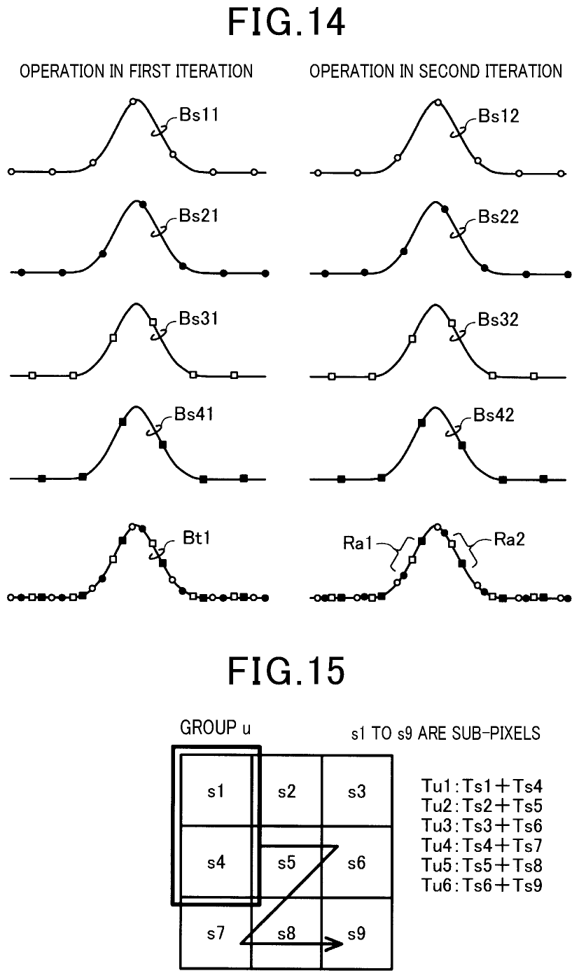

Similarly, using the fact that the timing control signals Sa1 to Sa9 output from the memory selector 190 can be changed each time the numbers of SPAD responses As1 to As9 are repeatedly detected, the timings of the second and subsequent detections may be changed using the result of the first detection. This example is illustrated below as a fourth embodiment. FIG. 14 illustrates an example of measurement made by changing the timings of the second and subsequent detections depending on the result of the first detection. As in FIGS. 8 and 13, for convenience of understanding, FIG. 14 also illustrates the example of measurement in the presence of the sub-pixels s1 to s4 only, but it is obvious that it can be made in the presence of the sub-pixels s1 to s9.

In the example illustrated in FIG. 14, the first iteration is illustrated in the left column, and the second and subsequent iterations are illustrated in the right column. During the first iteration, the numbers of SPAD responses Bs11 to Bs41 for the sub-pixels s1 to s4 are read at the timings shifted relative to each other by one quarter of the light emitting and light receiving cycle, in the same way as illustrated in FIG. 8. The subscripts ij of the number of SPAD responses Bsij are defined in a similar manner as described with reference to FIG. 13.

During the first iteration, the numbers of SPAD responses Bs1 to Bs4 are integrated to acquire the integrated histogram Bt1. Detection of this integrated histogram Bt1 allows a position of a peak of reflected light to be approximately determined. Based on the integrated histogram Bt1 detected in the first iteration, the timing control signals Sa1 to Sa4 are adjusted such that finer detection can be performed at the rising and falling portions considered to form the peak. Specifically, in order that the numbers of SPAD responses can be finely detected at the rising portion Ra1 and the falling portion Ra2 of the waveform forming the peak, the timing control signals Sa1 and Sa2 for the sub-pixels s1 and s2 are slightly delayed. In addition, the timing control signal Sa3 for the sub-pixel s3 is slightly advanced, and the timing control signal Sa4 for the sub-pixel s4 is kept unchanged. In this way, the timing control signals Sa1 to Sa4 for the sub-pixels s1 to s4 can be focused on the rising portion Ra1 and the falling portion Ra2 of the waveform forming the peak. This enables acquisition of detailed information about the most important portions of the waveform forming the peak. The shapes of the rising and falling portions of the waveform forming the peaks can be used to determine whether the object OBJ1 that has been detected has a clear outline, such as metal or concrete, or an ambiguous outline, such as a tree or a human body.

In the present embodiment, the time interval of detections by the sub-pixels s1 to s4 is kept constant, and the detection phase is advanced or delayed for each sub-pixel. Instead, the timing control signals Sa output from the timing control unit 170 may be arbitrarily set including the time interval. In this way, the detection accuracy at the rising and falling portions of the reflected light pulse can be further improved. Of course, portions where the detection accuracy is improved, such as near the peak of the reflected light pulse, as well as the rising and falling portions, may be arbitrarily set. In the present embodiment, the detection phases for the second measurement are adjusted using the first measurement. Alternatively, based on the result of each measurement, the detection phases for the subsequent measurement may be adjusted.

### E. Fifth Embodiment

(1) Although some embodiments have been described above, other embodiments are also possible. A fifth embodiment is illustrated in which detection of the numbers of SPAD responses for the sub-pixels s1 to s9 is performed by grouping together a plurality of sub-pixels. In this case, in the configuration illustrated in FIG. 6, the histogram generators of the histogram generation unit 130 may, for example, alternately read the contents of the memories m1 and m2 and integrate them. Such a configuration for integrating the numbers of SPAD responses for a plurality of sub-pixels is illustrated in FIG. 15. In the example illustrated in FIG. 15, the histogram generators integrate the numbers of SPAD responses for two vertically aligned sub-pixels to generate a histogram. In this case, the histogram Tu1 generated as an integration of the numbers of SPAD responses for the sub-pixels s1 and s4 is denoted by Ts1+Ts4 where T1 is the histogram for the sub-pixel s1 and T4 is the histogram for the sub-pixel s4. The histogram generated as the integration of the numbers of SPAD responses for the plurality of sub-pixels is hereinafter referred to as a group histogram.

In the example illustrated in FIG. 15, each group histogram is as follows.

Tu1: Ts1+Ts4

Tu2: Ts2+Ts5

Tu3: Ts3+Ts6

Tu4: Ts4+Ts7

Tu5: Ts5+Ts8

Tu6: Ts6+Ts9

By adopting such a configuration, an object existing across the positions of two sub-pixels aligned vertically with respect to the pixel 66 can be detected with high accuracy.

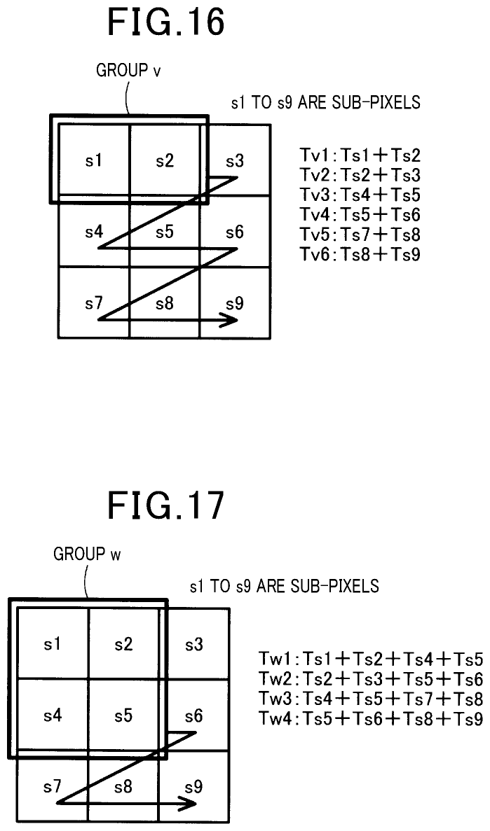

(2) The way to group together sub-pixels when acquiring a group histogram is not limited to the example illustrated in FIG. 15. Alternatively, the sub-pixels adjacent to each other horizontally may be grouped together, as illustrated in FIG. 16. In this case, group histograms Tv1 to Tv6 are defined by the following correspondence.

Tv1: Ts1+Ts2

Tv2: Ts2+Ts3

Tv3: Ts4+Ts5

Tv4: Ts5+Ts6

Tv5: Ts7+Ts8

Tv6: Ts8+Ts9

The method of detecting a position of an object and measuring a distance to the object in this case is the same as that illustrated in the above embodiment. In this way, an object existing across the positions of the two sub-pixels 69 aligned horizontally with respect to the pixel 66 can be detected with high accuracy.

(3) The present embodiment is not limited to the case where the histograms Ts for the sub-pixels are grouped two by two, but may be grouped M (M≥3) by M. FIG. 17 illustrates a case where they are grouped four by four. In this case, the histograms Ts1 to Ts9 are grouped together four by four and integrated to acquire group histograms Tw. Specifically, the group histograms Tw are defined by the following correspondence.

Tw1=Ts1+Ts2+Ts4+Ts5

Tw2=Ts2+Ts3+Ts5+Ts6

Tw3=Ts4+Ts5+Ts7+Ts8

Tw4=Ts5+Ts6+Ts8+Ts9

The process of acquiring the group histograms Tw and detecting an object and measuring a distance to the object is similar to other embodiments.

In this way, the SPAD calculation unit 100 can detect a spatial position of the object OBJ1 present in the predefined region according to the superposition of results of temporally spaced detections by some of the plurality of sub-pixels s1 to s9, whose detection phases are different from each other, at a resolution higher than the resolution in terms of pixels 66.

### F. Sixth Embodiment

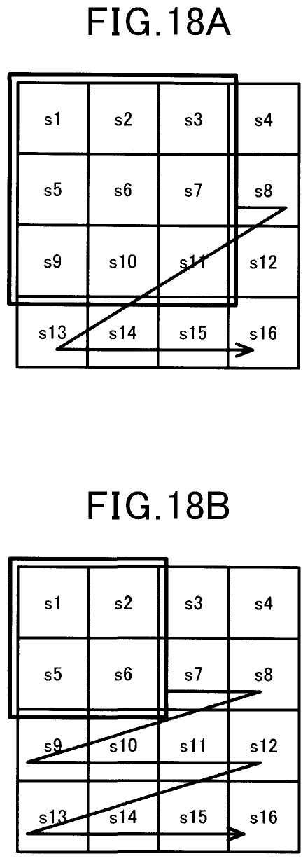

A configuration in which the number and combination of such sub-pixels are changed in the middle of the measurement is illustrated as a sixth embodiment. In the sixth embodiment, as illustrated in FIGS. 18A and 18B, where the pixel 66 is formed of 4×4 sub-pixels (16 sub-pixels in total), grouping may be performed with 3×3 sub-pixels or with 2×2 sub-pixels. Such grouping may advantageously be performed by increasing the number of sub-pixels to be grouped together when the time of flight of reflected light is short and the object OBJ1 can be determined to be nearby in the first iterative detection, and by decreasing the number of sub-pixels pixels to be grouped together when the time of flight of reflected light is long and the object OBJ1 can be determined to be far away in the first iterative detection. This is because if the object OBJ1 is nearby, the reflected light from the object OBJ1 is likely to enter multiple sub-pixels at the same time, while if the object OBJ1 is far away, the reflected light from the object OBJ1 is less likely to enter multiple sub-pixels. In addition, the combination of sub-pixels may be changed in the middle of the measurement. For example, if it is determined that an elongated object is likely to exist in the vertical direction, the combination of sub-pixels is made to be vertical, and if it is determined that an elongated object is likely to exist in the horizontal direction, the combination of sub-pixels is made to be horizontal. The number of sub-pixels to be vertically or horizontally combined may be referred to as a binning number.

In this way, it is easy to switch between prioritizing the temporal resolution and the spatial resolution by changing the binning number, depending on the distance to the object OBJ1. Increasing the number of sub-pixels to be grouped leads to increased numbers of SPAD responses included in the group histogram. Therefore, the time required to generate the histogram can be reduced, and the number of scans can be increased by reducing the number of measurements at the same scanning position.

### G. Other Embodiments

Part of the configuration implemented using hardware in the above-described embodiments can be implemented using software. At least part of the configuration implemented using software can be implemented using a discrete circuit configuration. Additionally, where some or all of the functions of the present disclosure are implemented through software, the software (computer program) may be provided as being stored in a computer-readable storage medium. The “computer-readable storage medium” is not limited to a portable storage medium such as s flexible disk or a CD-ROM, but also includes a computer internal storage device, as well as an external storage device such as a hard disk attached to a computer. That is, the “computer-readable storage medium” has a broad meaning that includes any storage medium in which data packets can be fixed rather than temporary. In addition, the process performed in the above optical ranging device can be understood as being implemented as an optical ranging method.

The present disclosure is not limited to any of the embodiments, examples or modifications described above but may be implemented by a diversity of other configurations without departing from the scope of the disclosure. For example, the technical features of the embodiments, examples or modifications corresponding to the technical features of the respective aspects may be replaced or integrated appropriately, in order to solve part or all of the issues described above or in order to achieve part or all of the advantages described above. Any of the technical features may be omitted appropriately unless the technical feature is described as essential herein.

What is claimed is:

1. An optical ranging device for measuring a distance to an object using light, comprising:
a light emitting unit configured to emit pulsed light into a predefined region;
an optical system configured to image reflected light from the predefined region corresponding to the pulsed light to a pixel that performs detection;
a light receiving unit including a plurality of sub-pixels arranged within the pixel, each of the plurality of sub-pixels being configured to detect the reflected light;
a timing control unit configured to cause detection of the reflected light, which is repeated at time intervals by at least some of the plurality of sub-pixels, and detection of the reflected light, which is repeated at the time intervals by others of the plurality of sub-pixels, to be performed at different phases; and
a determination unit configured to, using a result of detection of the reflected light repeated at the time intervals by each of the plurality of sub-pixels, determine a spatial position of the object present in the predefined region range, including a distance to the object.

2. The optical ranging device according to claim 1, wherein
each of the plurality of sub-pixels includes a plurality of light detection circuits that are configured to individually detect light incidence as an electrical response signal, and
the determination unit includes, for each of the plurality of sub-pixels, an integrator configured to integrate a number of response signals from the light detection circuit included in the sub-pixel at each timing of detection of the reflected light repeated at the time intervals, and a memory configured to store the integrated number of response signals for at least one ranging cycle.

3. The optical ranging device according to claim 2, wherein
each of the plurality of light detection circuits includes a single photon avalanche diode (SPAD).

4. The optical ranging device according to claim 1, wherein
the timing control unit is configured to cause detection of the reflected light repeated at the time intervals by each of the plurality of sub-pixels to be performed at a different phase.

5. The optical ranging device according to claim 1, wherein
the timing control unit is configured to set the time intervals at which detection of the reflected light is repeated by each of the plurality of sub-pixels to be constant.

6. The optical ranging device according to claim 1, wherein
the timing control unit is configured to change the time intervals at which detection of the reflected light is repeated by each of the plurality of sub-pixels.

7. The optical ranging device according to claim 6, wherein
the timing control unit is configured to, prior to changing the time intervals, perform emission of the pulsed light and detection of the pulsed light using the sub-pixels, and based on a result of the detection, determine the time intervals.

8. The optical ranging device according to claim 1, wherein
the time intervals at which detection of the reflected light is repeated by each of the plurality of sub-pixels are shorter than a width of the pulsed light to be emitted by the light emitting unit.

9. The optical ranging device according to claim 1, wherein
the determination unit is configured to perform a first process of detecting the object present in the predefined region at a first spatial resolution and at a first temporal resolution, according to a result of detection of the reflected light repeated at the time intervals by each of the the plurality of sub-pixels, and a second process of detecting the object present in the predefined region at a second spatial resolution lower than the first spatial resolution and at a second temporal resolution higher than the first temporal resolution, according to a result of superimposition of temporally spaced detections by the plurality of sub-pixels whose detection phases are different from each other.

10. The optical ranging device according to claim 1, wherein
the determination unit is configured to detect a spatial position of the object present in the predefined region at a resolution higher than the resolution in terms of the pixel, according to a result of superimposition of temporally spaced detections by a plurality of the sub-pixels whose detection phases are different from each other.

11. The optical ranging device according to claim 10, wherein
a number of the sub-pixels whose temporally spaced detections are superimposed is variable.

12. The optical ranging device according to claim 10, wherein
prior to changing the number of the sub-pixels whose temporally spaced detections are superimposed, emission of the pulsed light and the temporally spaced detections using these sub-pixels are performed, and the number of the sub-pixels whose temporally spaced detections are superimposed is determined based on a result of the temporally spaced detections.

13. An optical ranging method for measuring a distance to an object using light, comprising:
emitting pulsed light into a predefined region;
imaging reflected light from the predefined region corresponding to the pulsed light to a pixel that performs detection, within which a plurality of sub-pixels arranged, each of the plurality of sub-pixels being configured to detect the reflected light;
causing detection of the reflected light, which is repeated at time intervals by at least some of the plurality of sub-pixels, and detection of the reflected light, which is repeated at the time intervals by others of the plurality of sub-pixels, to be performed at different phases; and
using a result of detection of the reflected light repeated at the time intervals by each of the plurality of sub-pixels, thereby determining a spatial position of the object present in the predefined region range, including a distance to the object.
